(19) United States
(12) Patent Application Publication
(10) Pub. No.: US 2015/0120880 A1
(43) Pub. Date: Apr. 30, 2015

(54) SYSTEM AND METHODS FOR ACCESSING CONTENT STORED ON A LOCAL AREA NETWORK OF A COMPANY

(71) Applicant: BOUYGUES TELECOM, Paris (FR)

(72) Inventors: Christophe Du Laurent De La Barre, Saclay (FR); Guillaume Foltran, Sevres (FR); Nicolas Motron, Paris (FR); Sebastien Roger, Fontenay Le Fleury (FR)

(21) Appl. No.: 14/398,969

(22) PCT Filed: May 2, 2013
(86) PCT No.: PCT/EP2013/059163

§ 371 Date: Nov. 4, 2014

(30) Foreign Application Priority Data
May 4, 2012 (FR) 1254143

(51) Int. Cl. H04L 29/08

(52) U.S. Cl. CPC H04L 67/32; H04L 67/10
USPC 709/219

(57) ABSTRACT

The present invention concerns a system for accessing content stored on at least one server (5) of a secure local area network (20) from a device (1), said device (1) being connected to the local area network (20) via the Internet network (10), the system being characterised in that it comprises at least one publication server (3) connected to the device (1) via the Internet network (10) and an aggregation server (4) connected to said server (5) via the local area network (20); and in that, when the publication server (3) receives a request from the device (1) for access to said content of the server (5), the request comprising at least one valid connection identifier, said publication server (3) is capable of establishing a secure connection with said aggregation server (4); and in that the aggregation server (4) implements a content aggregation engine capable of collecting content from the server (5) via said local area network (20) on request, and of aggregating and then transmitting said collected content to the publication server (3). The present invention further concerns content transfer methods.

### GENERAL TECHNICAL FIELD

This invention relates to the field of company local area networks, and more precisely a system for accessing content stored on at least one server of such a secure network from a device.

### STATE OF THE ART

Companies most often have a private local area network (LAN), commonly referred to as “intranet”.

This network interconnects all of the workstations of the company, and is itself connected to the Internet, generally via proxies, which secure the interface by implementing firewall, filtering, etc. functions. Access to the intranet is consequently impossible if one is not physically connected to the local area network, which provides the best protection possible against intrusions.

The interest of an intranet is indeed to enable the free sharing of professional data and communication within the company, without outside third parties, who could be competitors, able to access the data that is shared and exchanged. This data can be work documents produced by the employees, but also often internal communication data. Many companies for example have a web portal configured as a starting page for browsers of the workstations of the company, with this portal offering a gateway to many resources of the company such as a directory, agendas, news lists, etc.

Although the content made available via an intranet does not have the vocation of being able to leave the company network, it is desirable for employees sometimes to be able to have access to it although they are outside of the premises of the company (for example from their homes with their personal computer, from the Wifi of a hotel or from a customer with their portable computer when they are travelling, etc.).

For this, a solution has been proposed of “extending” a local area network, via VPNs (“Virtual Private Network”). This entails using the Internet as a transmission support by using a tunnelling protocol, for example L2TP (“Layer 2 Tunnelling Protocol”), i.e. by encapsulating the data to be transmitted in an encrypted manner. “VPN” is then used in order to designate the network that is as such artificially created. This network is virtual because it connects two “physical” networks (here, on the one hand, the local area network constituted of the remote user and his box providing him with access to the Internet, and on the other hand the local area network of the company) via a non-reliable and private connection (Internet), as this technique still makes it possible to prevent unauthorised third parties from accessing the intranet since the tunnel is secure. In other terms, the remote private network of the user is virtually “added” to the local area network of the company.

Note that it is most often this technique hat enables the intranet of a company to be constituted of several small networks connected by tunnels if the company is located over several separate sites.

Alternatively, secure communications protocols such as SSH allow a user to remotely connect to his professional workstation (which is physically located in the local area network of the company) with the condition that an agent is installed on the target workstation. The interest with SSH is that it is a purely software solution, while using VPNs requires specifically configured routing devices.

All of these techniques provide satisfaction but have several disadvantages. On the one hand, these technologies are not within reach of all neophytes, as complex manipulations are to be made both on the remote workstation and within the local area network of the company. On the other hand, the quality of the service is limited. For these reasons, users generally try whenever possible to avoid having to use the intranet when they do not have a physical connection with the local area network of the company. Moreover, note that these techniques operate poorly and even not at all on the new IT devices that have particular connections to the Internet (Wi-Fi, 3G, etc.) such as touch-screen tablets and smartphones.

It would as such be interesting to have a more ergonomic and practical, but still also secure, way to access the content of the company remotely.

### PRESENTATION OF THE INVENTION

According to a first aspect, this invention therefore relates to a system for accessing content stored on at least one server of a secure local area network from a device, with the device being connected to the local area network via the Internet network, with the system being characterised in that it comprises at least one publication server connected to the device via the Internet network and an aggregation server connected to said server via the local area network;

in that, when the publication server receives from the device a request to access said content of the server, with the request comprising at least one valid connection identifier, said publication server is able to establish a secure connection with said aggregation server; and in that the aggregation server implements a content aggregation engine able to collect content from the server via said local area network on request, and to aggregate then transmit said collected content to the publication server.

According to other advantageous and non-limited characteristics:

the content collected by the aggregation server is aggregated in a form adapted to the device;

the local area network is connected to the Internet network via a proxy configured to authorise a secure connection between the publication server and the aggregation server;

the device is a touch-screen tablet or a mobile terminal;

the connection between the device and the publication server is also a secure connection;

the publication server is connected via the Internet network to an authentication server wherein the valid connection identifiers are listed;

the aggregation server is connected to a server via a connector, with each connector able to convert a content feed from a specific language to a language of said aggregation engine, and inversely;

the device, the publication server and the aggregation server communicate via the XML (eXtensible Markup Language) format, with the aggregation server comprising means of converting said language of the aggregation engine into XML, and inversely;

the device has an interface wherein connection identifiers of a user of the device are stored, with said interface comprising means of identification that are able, when the user has been validly identified on the device, to associate said identifiers of the user with a request to access said content of the server;

the content of at least one server is chosen from among work documents, press review articles, data from the social network of the company.

According to a second and a third aspect, the invention relates to methods, in particular a method for transferring content present on at least one server connected to a local area network to a device connected to the Internet network, characterised in that it comprises steps of:

Sending a request to transfer said content from the device to a publication server connected to the Internet network, with the request comprising at least one connection identifier;

Verifying the connection identifier by the publication server;

If the connection identifier is valid, transferring said request from the publication server to an aggregation server connected to said local area network;

Collecting said content on the server or servers by the aggregation server;

Aggregating content in the form adapted to the device by an aggregation engine implemented by the aggregation server;

Transferring aggregated content to the device via the publication server.

The other method is a method for transferring content from a device connected to the Internet network to a server connected to a local area network, characterised in that it comprises steps of:

Sending a request to transfer said at least one content from the device to a publication server connected to the Internet network, with the request comprising the content and at least one connection identifier;

Verifying the connection identifier by the publication server;

If the identifier is valid, transferring said request from the publication server to an aggregation server connected to said local area network;

Transferring said content on the server from the aggregation server.

### PRESENTATION OF THE FIGURES

Other characteristics and advantages of this invention shall appear when reading the following description of a preferred embodiment. This description shall be given in reference to the annexed drawings wherein:

FIG. 1 is a diagram of the system according to the invention;

FIG. 2 shows an example of the aggregated content displayed on a device thanks to the system according to the invention.

### DETAILED DESCRIPTION

### Network Architecture

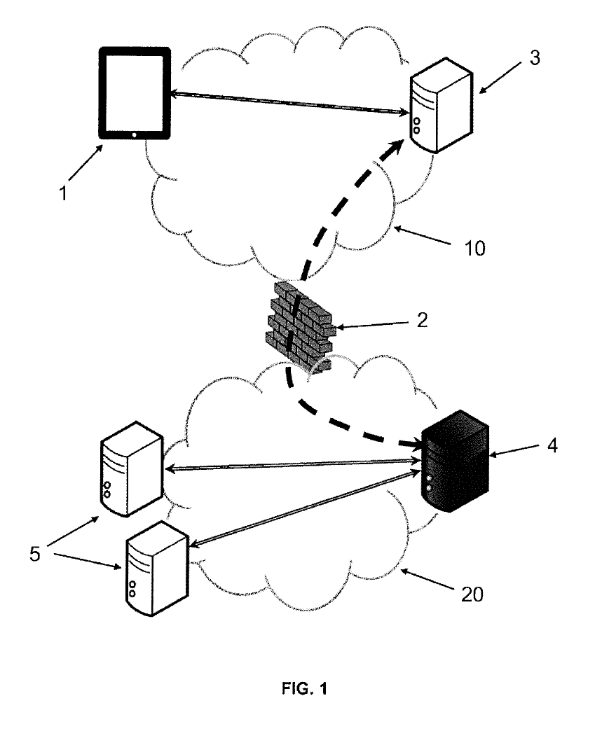

In reference to the drawings and in particular to FIG. 1, the invention relates to a system comprising on the one hand a device 1 and a server 3 referred to as a publication server connected to the Internet network 10, and on the other hand at least one server 5 and a so-called aggregation server 4 connected to a local area network 20 of a company.

As explained hereinabove, the local area network 20 of the company is in particular a private and secure network, which means that it is connected to the Internet network 10 via one or several proxy servers 2, that implement filtering and firewall functions that “isolate” the local area network 20 from the rest of the Internet 10, in such a way as to prevent access from the outside in particular to the servers 5. It is indeed understood that these servers 5 can be any server of the company that has means of storage whereon are stored content (for example work documents such as presentations or spreadsheets, plans, administrative documents, but also documents such as directories, news, schedules, company social network data, and any other data for which the distribution can be interesting within the intranet of the company, but which is not intended for any usage other than internal). The servers 5 can as such be any workstation of the company, even dedicated servers delivering content feed.

The device 1 can be any IT device able to connect to the Internet 10, such as a portable computer. However, preferably, it is a roaming device such as a touch-screen tablet or a mobile terminal (a smartphone). These devices are indeed able to connect to a network very easily (via 3G, a Wi-Fi access point, etc.) and offer a specific ergonomic interface that can be advantageously used to improve the comfort of a user who is trying to access his professional content. In contrast, the known techniques are in general not compatible with IT devices other than a computer. In addition, these techniques generally only enable the display of an interface that is not very practical.

It is understood in the rest of this description that “access” to the content of a local area network of the company must not be understood solely as the consulting (“downloading”) of this content, but also modifying it, and even adding content (“uploading”), The connectivity offered by the system according to the invention is bi-directional.

### Publication Server

The publication server 3 is the server that will enable the distribution of the content to the authorised devices; this is why it is referred to as “publication”.

This publication server 3 can be any web server that has means for processing data, means of data storage and network connectivity. It is able, when it receives from the device 1 a request to access content of the server 5 associated with at least one valid connection identifier, to establish a secure connection (by secure, encryption is meant in particular) with the aggregation server 4.

As can be seen in FIG. 1, it is indeed the end of the single connection channel between the Internet network 10 and the local area network 20 allowed by the system according to the invention. This channel is similar to the tunnel implemented by a VPN (the proxy 2 is as such advantageously configured to authorise this secure connection between the publication server 3 and the aggregation server 4, contrary to most of the other uplink connections), with the difference that here it does not involve the device 1 that is trying to connect, or the server 5 that contains the targeted content. When the secure connection is established, the data packets circulate encapsulated in an encrypted communications protocol such as SSL (“Secure Socket Layer”) or TLS (“Transport Layer Security”) in particular as 128 bits.

The connection of the device 1 to the publication server 3 is itself advantageously also secure, so that there is no point of vulnerability in the local area network 20. This connection is made for example via the HTTPS (“HyperText Transfer Protocol Secure”) protocol, which corresponds to HTTP again with an encryption layer of the SSL or TLS type, in particular as 128 bits.

As explained, a request for content emitted from the device 1 contains one or several connection identifiers. The latter are for example a personal identifier (“login”)/password pair of an employee of the company. The mandatory key-entry of them prevents third parties from accessing the internal content even if they have stolen the device 1 of the user. The connection identifiers entered and therefore attached to the request (regardless of the form of the request) are verified on the publication server 3. This verification can have many forms such as the implementation of an algorithm that calculated an expected password using an identifier, but advantageously the publication server is connected to a so-called authentication server (in particular a server that implements an LDAP (“Lightweight Directory Access Protocol”) directory, for example Microsoft's Active Directory) whereon is stored a database of valid connection identifiers, for example all of, the passwords of the employees of the company. This authentication server can be local (connected to the network 20) or not (connected directly to the Internet 10).

A request emitted by the device 1 can have many forms. This can be a request for particular content, for example a work document, or a request for a set of content that is not precisely identified, for example the latest news of the company. The request can, as shall be shown, contain data aiming to modify content, and even entirely new content. The system according to the invention as such makes it possible, following a first request to display content, to post via a second piece of content comments on a new article, a message in a company social network, etc. Such a request does not necessarily expect a return if it is only an update to the content (display of the posted message for example).

In a particular preferred manner, the device 1 has an interface (in particular specific to the type of device that the device 1 is) wherein connection identifiers of a user of the device 1 are stored, with said interface comprising means of identification that are able, when the user has been validly identified on the device 1, to associate said identifiers of the user with a request to access said content of the server 5.

By way of example, this can be an application that the user downloads and installs on his device 1, and for which at the first use of the latter the user is prompted to key-enter for memorisation his personal identifier/password pair, as well as a personal PIN code. On a regular basis and/or each time that the user launches this interface, he is asked again for his PIN code. In the case of a touch-screen tablet, the means for identifying the user of the device then consist for example of a virtual number keypad that is displayed and whereon it is sufficient for him to enter his PIN code in order to confirm his identity. If the PIN code is correct, the interface will automatically populate the connection identifiers of the user in the next request or requests emitted. It is however of course possible to implement a manual mode wherein the user has to enter his identifiers for opening the interface.

This simplified identification substantially decreases the time required to establish the secure connection and to obtain the desired content in relation to what was required with a VPN. A much more spontaneous use becomes possible.

### Aggregation Server

The aggregation server 4 is the counterpart in the local area network 20 of the publication server 3. In addition to its function as an access point in the content of the server or servers 5, it has the specificity of implementing a content aggregation engine (thus its name) able to collect on request content of the server 5 via said local area network 20, and above all to aggregate this content into a format adapted to the device 1.

Similar to what is done for portals, aggregating content consists in having a plurality of it on a single page in a compact and ergonomic manner. For example, in the case where the content is news articles, the aggregation engine is able, in the case of a request for new content, to generate a page comprising for example for each article a preview block containing a photo and a few lines. This aggregated format is furthermore advantageously adapted to the device 1. “Adapted to the device” means here that the format of the aggregated content can be read in terms of encoding, resolution, features (for example hypertext zones adapted to a touch-screen interface) with the types of devices intended to be used such as devices 1. In the case where the device has a specific interface, it is possible to indicate to the aggregation server 4 of what type the device 1 is, and to consequently refine the aggregation. This personalisation of the format of the content is very appreciated in terms of ergonomics for the users.

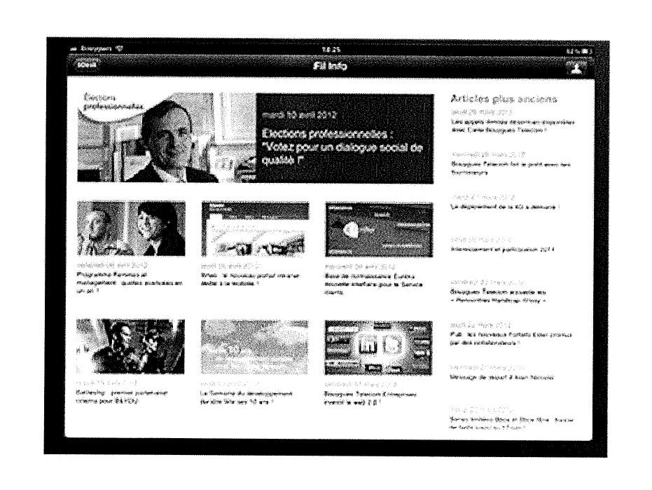

By way of example, FIG. 2 shows content of the company news type aggregated on a manner that is adapted to a touch-screen tablet. It shows for example a left portion that includes “headline” articles with for a certain number of articles a photo and a preview, and in the right portion a bar with all of the articles that can be selected. In the “landscape” format such as shown, the view of the content can switch to “portrait” format where the right bar would disappear leaving room for a larger number of headline articles.

### Connectors and Format Conversion

The device 1, the publication server 3 and the aggregation server 4 communicate advantageously via the XML (“eXtensible Markup Language”) format. URLs (“Uniform Resource Locator”) are inserted into the XML messages for the images and other data that is not textual. The latter are transmitted in specific packets in binary format and are loaded after the rest of the content, which means that the user can as soon as the text is received start to read the content without possibly being hindered by the loading time of any large images.

This simple and widespread language XML as such makes it possible to save time during the displaying in particular on tablets.

The content feed coming from servers 5 are in a plurality of formats which are most often proprietary. In order to facilitate the aggregation of the content, the aggregation server 4 of the system according to the invention advantageously has “connectors”, i.e. software modules able to provide for the conversion from a given feed language to a working language of the aggregation engine, and inversely. For example, a SharePoint connector makes it possible to have a service for accessing SharePoint documents and integrating RSS Newsgator feeds. An architecture can be considered wherein the aggregation server 4 would as such have a connector per type of service.

The working language of the aforementioned aggregation engine is advantageously an object-oriented language, which is converted into XML (via algorithms which are themselves in object-oriented language, for example C#) at the output of the aggregation engine by another connector.

Once in aggregated form, the content is sent encapsulated and encrypted via the same channel as the request. It passes through the proxy 2 and is sent to the publication server 3 that retransmits it in a secure manner to the device 1 (more precisely the dedicated interface if it has one) which will display it, for consultation by the user or for modification. A new request is emitted at each new navigation action performed by the user. This operation is entirely transparent for the user who has the impression of accessing the resources of the company as easily (and even more effectively thanks to the data aggregation) as if he we directly connected to the local area network 20.

### Methods

This invention relates to according to a second and a third aspect methods for transferring content, respectively in the downlink direction (transfer from the server 5 to the device 1, i.e. “downloading”) and in the uplink direction (transfer from the device 1 to the server 5, i.e. “uploading”),

The first method is therefore a method for transferring content present on at least one server 5 connected to a local area network 20 to a device 1 connected to the Internet network 10. It comprises as explained hereinabove steps of:

Sending a request to transfer said content from the device 1 to a publication server 3 connected to the Internet network 10 (in particular thanks to a secure protocol of the HTTPS type), with the request comprising at least one connection identifier;

Verifying the connection identifier by the publication server 3 (for example by comparison with the database of identifiers of an LDAP authentication server);

If the connection identifier is valid, transferring said request from the publication server 3 to an aggregation server 4 connected to said local area network 20, with the connection between these servers 3 and 4 being in particular a tunnel offering an encrypted connection;

Collecting said content on the server or servers 5 by the aggregation server;

Aggregating content in a form adapted to the device 1 by an aggregation engine implemented by the aggregation server 4;

Transferring aggregated content to the device 1 via the publication server 3 (by retracing the established secure channels).

Inversely, the second method is a method of transferring content from a device 1 connected to the Internet network 10 to a server 5 connected to a local area network 20, which comprises a certain number of steps common with the first method, in particular the steps of:

Sending a request to transfer said at least one piece of content from the device 1 to a publication server 3 connected to the Internet network 10, with the request comprising the content and at least one connection identifier;

Verifying the connection identifier by the publication server 3;

If the identifier is valid, transferring said request from the publication server 3 to an aggregation server 4 connected to said local area network (20);

It is then distinguished in that it comprises only one step of:

Transferring said content on the server 5 from the aggregation server 4.

1. System for accessing content stored on at least one server (5) of a secure local area network (20) from a device (1), with the device (1) being connected to the local area network (20) via the Internet network (10), with the system being characterised in that it comprises at least one publication server (3) connected to the device (1) via the Internet network (10) and one aggregation server (4) connected to said server (5) via the local area network (20);
in that, when the publication server (3) receives from the device (1) a request to access said content from the server (5), with the request comprising at least one valid connection identifier, said publication server (3) is able to establish a secure connection with said aggregation server (4); and
in that the aggregation server (4) implements a content aggregation engine able to collect content from the server (5) via said local area network (20) on request, and to aggregate then send (3) said collected content to the publication server.

2. System as claimed in the preceding claim, wherein the content collected by the aggregation server (4) is aggregated into a form adapted to the device (1).

3. System according to one of the preceding claims, wherein the local area network (20) is connected to the Internet network (10) via a proxy (2) configured to authorise a secure connection between the publication server (3) and the aggregation server (4).

4. System according to one of the preceding claims, wherein the device (1) is a touch-screen tablet or a mobile terminal.

5. System according to one of the preceding claims, wherein the connection between the device (1) and the publication server (3) is also a secure connection.

6. System according to one of the preceding claims, wherein the publication server (3) is connected via the Internet network (10) to an authentication server wherein the valid connection identifiers are listed.

7. System according to one of the preceding claims, wherein the aggregation server (4) is connected to a server (5) via a connector, with each connector being able to convert a content feed from a specific language to a language of said aggregation engine, and inversely.

8. System according to one of the preceding claims, wherein the device (1), the publication server (3) and the aggregation server (4) communicate via the XML (eXtensible Markup Language) format, with the aggregation server (4) comprising means for converting said language of the aggregation engine into XML, and inversely.

9. System according to one of the preceding claims, wherein the device (1) has an interface wherein the connection identifiers of a user of the device (1) are stored, with said interface comprising means of identification that are able, when the user has validly identified himself on the device (1), to associate said identifiers of the user with a request to access said content of the server (5).

10. System according to one of the preceding claims, wherein the content of at least one server (5) is chosen from among work documents, press review articles, company social network data.

11. Method for transferring content present on at least one server (5) connected to a local area network (20) to a device (1) connected to the Internet network (10), characterised in that it comprises steps of:
Sending a request to transfer said content from the device (1) to a publication server (3) connected to the Internet network (10), with the request comprising at least one connection identifier;
Verifying the connection identifier by the publication server (3);
If the connection identifier is valid, transferring said request from the publication server (3) to an aggregation server (4) connected to said local area network (20);
Collecting said content on the server or servers (5) by the aggregation server;
Aggregating content in the form adapted to the device (1) by an aggregation engine implemented by the aggregation server (4);
Transferring aggregated content to the device (1) via the publication server (3).

12. Method for transferring content from a device (1) connected to the Internet network (10) to a server (5) connected to a local area network (20), characterised in that it comprises steps of:
Sending a request to transfer said at least one piece of content from the device (1) to a publication server (3) connected to the Internet network (10), with the request comprising the content and at least one connection identifier;
Verifying the connection identifier by the publication server (3);
If the identifier is valid, transferring said request from the publication server (3) to an aggregation server (4) connected to said local area network (20);
Transferring said content on the server (5) from the aggregation server (4).
